(19) United States
(12) Patent Application Publication
(10) Pub. No.: US 2012/0065797 A1
(43) Pub. Date: Mar. 15, 2012

(54) ENERGY MANAGEMENT SYSTEM INCORPORATING A GAS POWERED GENERATOR

(75) Inventors: Joseph Mark Brian, Louisville, KY (US); Michael Beyerle, Louisville, KY (US); Jay Broniak, Louisville, KY (US); David Bingham, Louisville, KY (US)

(73) Assignee: General Electric Company

(21) Appl. No.: 12/912,871

(22) Filed: Oct. 27, 2010

(51) Int. Cl. G06F 1/30

(52) U.S. Cl. 700/295

(57) ABSTRACT

An energy management system for a home network is provided. The energy management system comprises one or more power consuming devices and a central controller having a memory and a communication module. The controller is operationally connected to the power consuming devices. The energy management system further includes a user interface capable of providing energy data to a user, and an emergency power device enabled with a communication device communicatively linked to the communication module, such that information may be transmitted by one of the communication device and communication module, and received by the other of the communication device and communication module.

### BACKGROUND

This disclosure relates to an energy management system and more particularly to the management of devices in an energy management system. The disclosure finds particular application to incorporating an emergency power device, such as a generator, in energy management platforms.

Many utilities are currently experiencing a shortage of electric generating capacity due to increasing consumer demand for electricity. Currently utilities charge a flat rate, but with increasing cost of fuel prices and high energy usage at certain parts of the day, utilities have to buy more energy to supply customers during peak demand. Lowering peak demand provides a huge cost savings and lessens the peak load that the utility has to accommodate. In order to reduce high peak power demand, many utilities have instituted time of use (TOU) metering and rates which include higher rates for energy usage during on-peak times and lower rates for energy usage during off-peak times. As a result, consumers are provided with an incentive to use electricity at off-peak times rather than on-peak times and to reduce overall energy consumption of appliances at all times.

A home energy management system has been developed and described in U.S. Application No. ______ (GE 237986), fully incorporated by reference herein, that can automatically operate and disable power consuming devices in a designated home network in response to signals received from a utility. The energy management system includes a central controller that is in communication with each of the power consuming devices and provides a homeowner the means to monitor and manage their energy consumption through a combination of behavior modification and programmed control logic. Active and real time communication of energy costs of power consuming devices to the consumer enables informed choices for operating those power consuming functions.

The home energy management system is designed to manage the operation of power consuming devices in a home network and provide homeowners with power and cost saving information. It would be advantageous, however, to further include additional devices into the system, such as an emergency power device, and enable users to obtain information regarding the device that would be relevant in operating, not only the emergency power device, but also the energy management system as a whole. It would be particularly advantageous to obtain such information using the hardware already in place with the home energy management system.

### SUMMARY OF THE DISCLOSURE

In accordance with one aspect of the present disclosure, an energy management system for a home network is provided. The energy management system comprises one or more power consuming devices and a central controller having a memory and a communication module. The controller is operationally connected to the power consuming devices. The energy management system further includes a user interface capable of providing energy data to a user, and an emergency power device provided with a communication device communicatively linked to the communication module, such that information relating to the emergency power device may be transmitted by one of the communication device and communication module, and received by the other of the communication device and communication module.

In accordance with another aspect of the present disclosure, a method for providing information from an emergency power device to a central controller of an energy management system that includes at least one power consuming device and a central controller having a memory and a communication module operationally connected to the at least one power consuming device is provided. The method comprises establishing a communication path between an emergency power device and the central controller, transmitting real-time information from the emergency power device to the central controller, receiving the information into the central controller, and displaying the information to a user through a user interface

In accordance with yet another aspect of the present disclosure, an energy management system is provided comprising a network of energy consuming devices operationally connected to a controller. The system includes a power generator including a communication device and microprocessor, and a central controller comprising a communication module, wherein the microprocessor is capable of processing real-time information with respect to the generator and said communication device is configured to transmit the real-time information to the communication module of the central controller.

### BRIEF DESCRIPTION OF THE DRAWINGS

FIG. 1 is a prior art schematic illustration of an energy management system with one or more devices in accordance with one aspect of the present disclosure;

FIG. 2 is a schematic illustration of an energy management system including a generator in accordance with another aspect of the present disclosure;

FIG. 3 is a diagram illustrating an example methodology for data and communication flow; and

FIG. 4 is a flow diagram illustrating an example methodology for communication information from a generator to an energy management system.

### DETAILED DESCRIPTION OF THE PREFERRED EMBODIMENTS

As briefly described above, the home energy management system is an electrical system having a central controller operationally coupled to a home network of power consuming devices that provides a homeowner the means to monitor and manage their energy consumption through a combination of behavior modification and programmed control logic. The central controller provides real-time feedback on electricity, water, and natural gas consumption as well as providing data on renewable energy generation occurring at the home, such as solar photovoltaic generation, wind generation, or any other type of renewable energy generation.

The central controller also stores consumption data and provides data to a user via an associated user interface display. According to a first configuration, the central controller operates as a data server for providing data through an application programming interface (API) to a client application, which can then be used to present this data to the homeowner on a client device. Once data is received through the API, the client device/program uses this information to generate graphs of energy usage, generation and/or storage on the client device. In another configuration, data pertaining to the consumer's energy consumption, generated energy, and/or storage is displayed on a display, such as an LCD touch screen display, integral with the central controller. Additionally, through a web server hosted on a controller, the display on other devices in communication with the central controller, such as a homeowner's networked PC, or other device capable of running a web browser, may further be used to display energy data to a user.

A communication module, such as a ZigBee radio may be implemented to facilitate communication signals between the central controller and devices within the home, while a second radio operates similarly between the central controller and the utility, such as for demand response event signals/price signals. Any communication protocol can be implemented and the present disclosure is not limited to ZigBee as one of ordinary skill in the art will appreciate. The central controller therefore operates as a gateway device by caching or storing information from devices within a home, such as historical power consumption data, or demand response event information from the utility. The central controller therefore provides the necessary information from the utility to the appliances/appliance microcontrollers for them to operate in accord with the utility signals and/or user preferences.

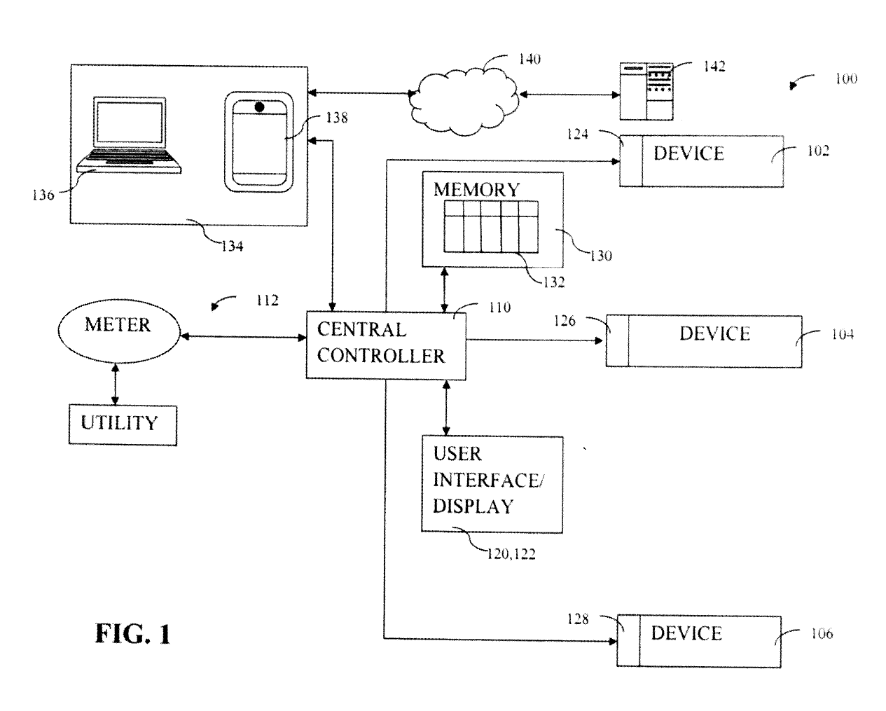

FIG. 1 schematically illustrates an exemplary home energy management system 100 for one or more power consuming devices, such as devices 102, 104, 106 as is presently known. Each of the devices 102, 104, 106 can comprise one or more power consuming features/functions. For example, device 104 can be a refrigerator, an HVAC system, and/or any energy consuming device capable of having power consumption measured thereat. The devices may also be controllers, or other energy consuming devices other than appliances. The home energy management system 100 generally comprises a central device or central controller 110 for managing power consumption within a household. The controller 110 is operatively connected to each of the power consuming features/functions. The controller 110 can include a micro computer on a printed circuit board, which is programmed to selectively send signals to a device control board 124, 126, 128 of device 102, 104, and/or 106 respectively in response to the input signal it receives. The device controller, in turn, is operable to manipulate energization of the power consuming features/functions thereof.

The controller 110 may include a user interface that may take various configurations as described above. The user interface 120 may be a display screen 122 that is integrally connected to the chassis housing of the central controller 110 having a display and control buttons for making various operational selections. The controller 110 may alternatively or additionally connect via either Ethernet or WiFi to a client program or the Internet 140. This allows for remote service and monitoring capability. A server 142 can keep records of all homes therein that may be accessed remotely via the internet. The display, whether integral to the central controller 110 or a client device 136, 138, can be configured to provide active, real-time feedback to the user on the cost of operating each appliance 102, 104, 106. The costs are generally based on the current operating and usage patterns and energy consumption costs, such as the cost per kilowatt hour charged by the corresponding utility. The controller 110 is configured to gather information and data related to current usage patterns and as well as current power costs, and generate historical usage charts therefrom. This information can be used to determine current energy usage and cost associated with using each device/appliance in one of the energy savings mode and normal mode. This real-time information (i.e., current usage patterns, current power cost and current energy usage/cost) can be presented to the user via the display.

In one embodiment, controller 110 is operable to provide feedback on natural resource use (e.g., electric, gas, water, and/or other) and the generation of natural resources at the home, for example. This information can be collected from power measuring devices, such as a power meter.

The controller 110 communicates to the sensor radios via one or more wireless radios. The interface radios may include ZigBee (802.15.4), WiFi (802.11), and an FM receiver. The device controller 110 can also include USB ports for adding additional functionality.

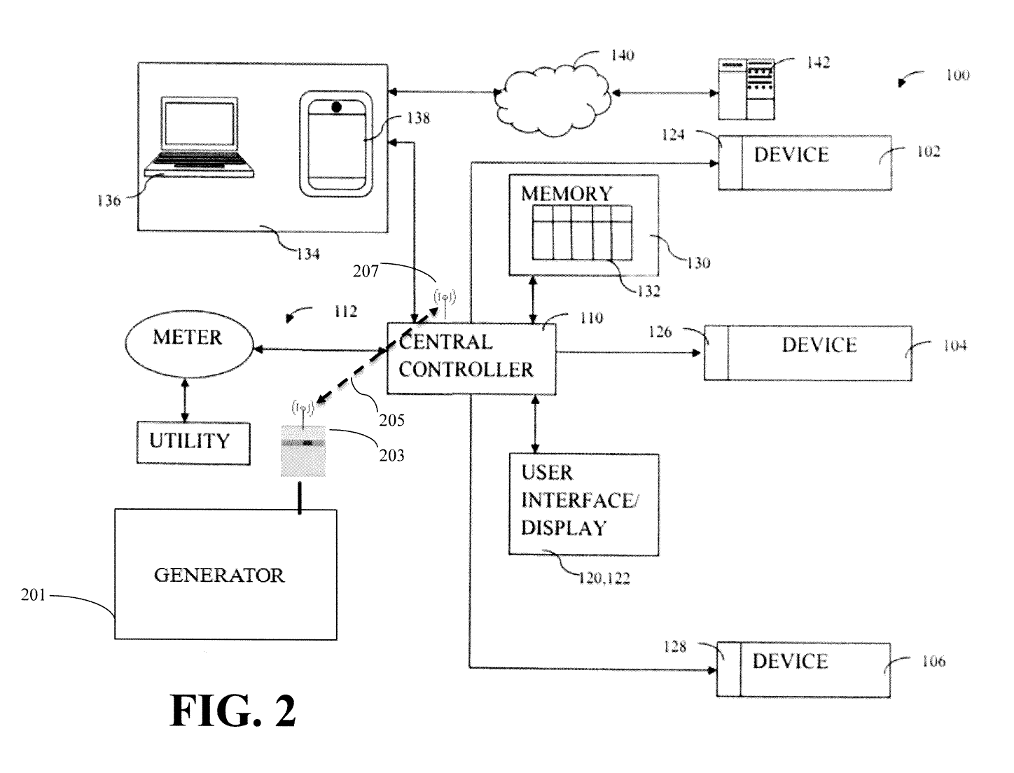

The central controller of the energy management system communicates with various power consumption devices in the home network by a communication module 207. In accordance with the present disclosure, the communication module 207 is additionally capable of communicating with an emergency power device, such as a generator 201 and back-up battery, as illustrated in FIG. 2. The generator 201 is equipped with a communication device 203 that is capable of establishing a communication path 205 between the generator 201 and the central controller 110. The communication path 205 enables the generator 201 to provide the energy management system 100 with real-time diagnostic and/or status information and parameters that can then be presented to a homeowner through a user interface on a controller display 122 or associated client device 136, 138.

A generator is typically implemented for supplying electricity to a home, office or other such structure, during periods that power from a utility may be unavailable. During an outage, the generator enables a homeowner to continue using essential appliances such as air conditioners, heaters, refrigerators, lights, etc. In the illustrated embodiments, the specific details of the generator construction have been omitted. It will be appreciated, however, that the generator may be any conventional generator, such as a gas-powered generator, and may run on a variety of fuels, such as gasoline, diesel, natural gas, propane, bio-diesel, sewage gas, hydrogen, and petroleum gas. Portable generators include fuel/gas tanks that can carry a limited amount of gas, and therefore, have a short run time. For long term emergency power, standby generators can provide continuous power because they are connected to an external fuel source, such as a natural gas line. Larger generator units also often include a battery to deliver high starting current in order to initially start the generator. Typical generator batteries include flooded plate types, gel cell types or absorbed glass matt batteries. Standby generator units often include an automatic starting system and a transfer switch to disconnect the load from the utility power source when there is a power failure and connect it to the generator.

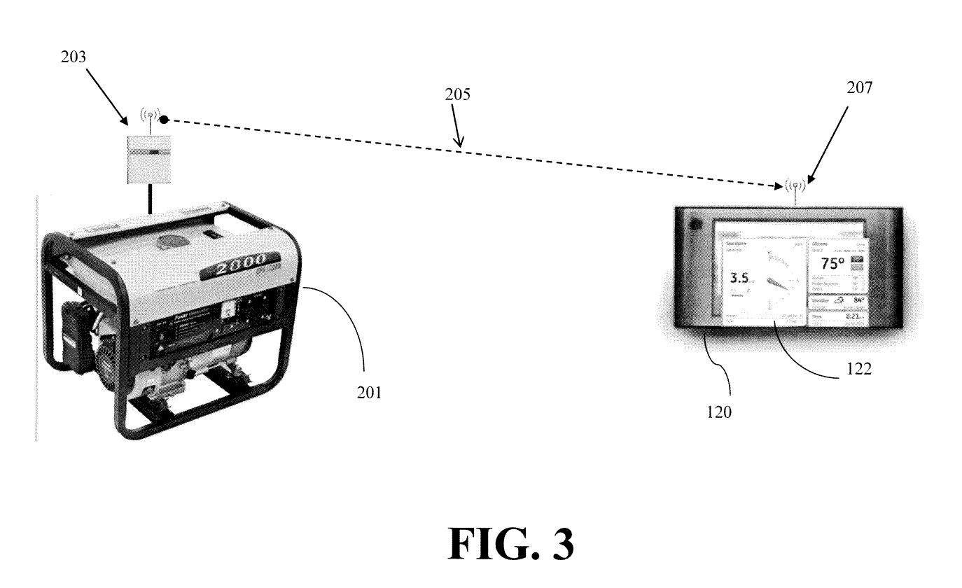

As best illustrated in FIG. 3, a generator 201 is in communication with a communication module 207 of the controller. The communication device 203 and communication module 207 can be utilized to transmit information to and from the generator 201 to a user via a display. As described above, the communication device 203 may be wireless or wired. There are several ways to accomplish this communication, including but not limited to power line carrier (PLC) (also known as power line communication), FM, AM SSB, WiFi, ZigBee, Radio Broadcast Data System, 802.11, 802.15.4, etc. For instance, the generator can have the following wireless capability: 802.11 WiFi, FM receiver, and 802.15.4 compliant Zigbee radios.

The communication device 203 provides a communication path 205 between the generator 201 and the communication module 207 of the central controller 110. Relevant information can then be communicated in real-time from the generator 201 to the energy management system 100 and displayed through an energy manager user interface. A homeowner can then make informed decisions regarding both the generator and the energy management system 100 based on the data received. A homeowner may input instructions and/or information requests into the user interface 120, which will then implement said communication module 207 to obtain the requested information from the generator to display to the homeowner.

The generator 201 is preferably configured to process and transmit infoimation such as status and diagnostic parameters. Status parameters include, but are not limited to, generator power output, available gas or fuel, number of hours in use, recommended service/maintenance based on run-time, oil and air filter maintenance alerts, efficiency, engine temperatures, backup battery status (% charge, voltage, charging current), and noise levels (dB). Additionally, the available diagnostic parameters may include information that can help a homeowner find problems in the operation of the generator and can provide general information about the generator and its capabilities. Exemplary parameters include, but are not limited to, 1) “based on current power output, you will run out of gas in X hours”, 2) “It is time to change the oil and/or air filter”, 3) “based on engine run-time, you should take your generator in for service”, 4) “the system battery is at 95% charge level”, 5) “The generator is out of gas, switching to battery power in 5 minutes”, and 6) “Based on current power consumption, your battery will be depleted in X hours”.

Based on the information provided by the generator 201 and presented to a homeowner via the user interface 120 on display 122 or through a client application 134 on to a user via a client device 136, 138, a homeowner can make informed choices on usage and maintenance of the generator along with choices regarding the energy management system itself. The user may further input commands into the user interface to instruct the operation of the generator. Such instructions may include when and when not to turn on, how long to operate, etc.

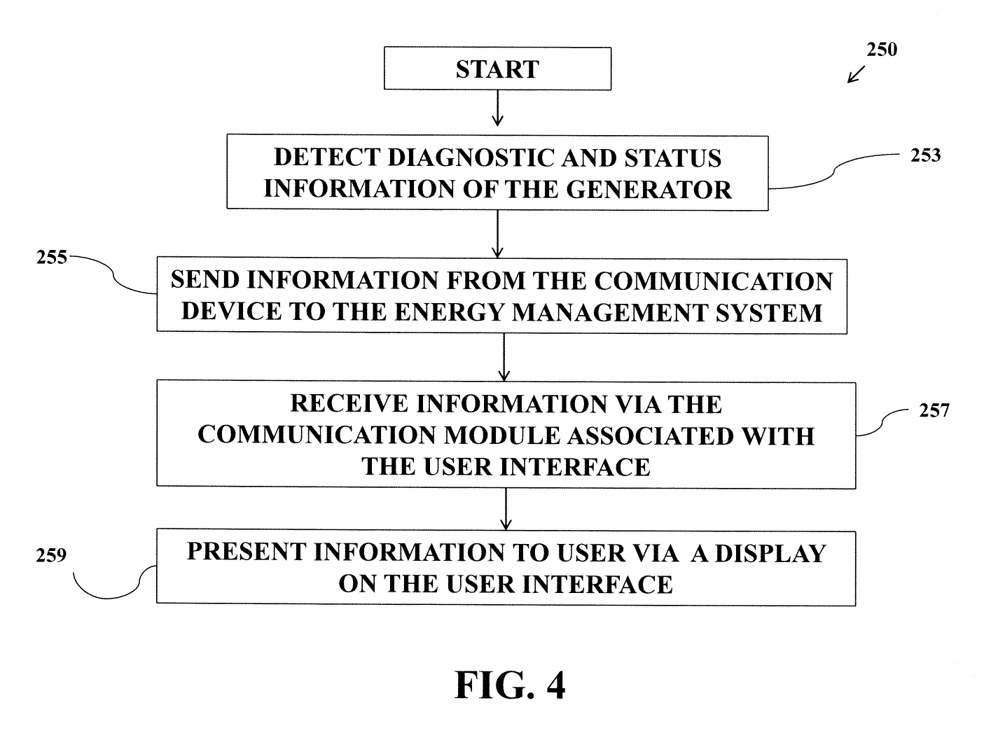

FIG. 4 illustrates an exemplary method 250 for providing information from an emergency power device to a user interface of an energy management system. While method 250 is illustrated and described below as a series of acts or events, it will be appreciated that the illustrated ordering of such acts or events are not to be interpreted in a limiting sense. For example, some acts may occur in different orders and and/or concurrently with other acts or events apart from those illustrated and/or described herein. Further, one or more of the acts depicted herein may be carried out in one or more separate acts and/or phases.

The method 250 begins at START. At step 253, information is collected by the generator's microprocessor, including information such as diagnostic and status parameters. The microprocessor then implements the generator communication device to transmit the collected information, in real-time, to the central controller of the energy management system at 255. At 257, the communication module of the central controller receives the information. At 259, the information is then presented to a user in real-time on a display. Alternatively, the information may be stored in the memory of the associated controller for a period of time, such as until the information is requested or has been inquired about by a user.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An energy management system for a home network comprising:
one or more power consuming devices;
a central controller having a memory and a communication module, said controller being operationally connected to the power consuming devices;
a user interface capable of providing energy data to a user; and
an emergency power device enabled with a communication device communicatively linked to said communication module, such that information may be transmitted by one of said communication device and communication module, and received by the other of said communication device and communication module.

2. The energy management system of claim 1, wherein said central controller includes an integral display capable of displaying said user interface.

3. The energy management system of claim 1, wherein said central controller is configured to operate as a data server passing information to a client application running on a client device for display of said user interface.

4. The energy management system of claim 1, wherein said emergency power device comprises a generator.

5. The energy management system of claim 4, wherein said generator comprise a gas-powered generator.

6. The energy management system of claim 1, wherein said information includes status parameters of the emergency power device, such as power output, available gas, number of run hours, recommended service/maintenance, oil and air filter maintenance, efficiency, engine temperatures, backup battery stats, and noise levels.

7. The energy manager system of claim 1, wherein said information includes diagnostic parameters of the emergency power device.

8. The energy management system of claim 7, wherein the diagnostic parameters include estimated hours of gas remaining, timing for changing air and/or oil filter, battery level remaining, and an indication the generator is switching from gas to battery.

9. The energy management system of claim 1, wherein a user is able to make informed decisions in said energy management system based on data available from said generator.

10. The energy manager system of claim 1, wherein said communication device is configured to provide said information to said central controller in real-time.

11. The energy manager system of claim 1, wherein at least one of said communication device and said communication module is a wireless radio.

12. A method for providing information from an emergency power device to a central controller of an energy management system including at least one power consuming device and a central controller, said central controller having a memory and a communication module operationally connected to the at least one power consuming device, said method comprising:
establishing a communication path between an emergency power device and said central controller;
transmitting real-time information from the emergency power device to the central controller;
receiving said information into the central controller; and
displaying said information to a user through a user interface.

13. The method according to claim 12, wherein communicating real-time information includes communicating at least one of real-time diagnostic, status, and device parameters.

14. The method according to claim 12, wherein establishing a communication path includes equipping said emergency power device with a communication device.

15. The method according to claim 12, further including making decisions in the energy management system based on the information transmitted by the emergency power device.

16. The method according to claim 12, wherein said emergency power device is a generator.

17. The method according to claim 12, further including storing said information in said memory of the central controller prior to displaying the information to the user, until requested by the user.

18. An energy management system comprising a network of energy consuming devices operationally connected to a controller, said system comprising:
a power generator including a communication device and microprocessor; and
a central controller comprising a communication module, wherein said microprocessor is capable of processing real-time information with respect to the generator and said communication device is configured to transmit said real-time information to the communication module of said central controller.

19. The energy management system of claim 18, wherein at least one of said communication device and said communication module is a wireless radio.

20. The energy management system of claim 18, wherein said information includes at least one of diagnostic and status information.
